(19) United States
(12) Patent Application Publication
(10) Pub. No.: US 2013/0130627 A1
(43) Pub. Date: May 23, 2013

(54) RADIO MEASUREMENT COLLECTION METHOD AND RADIO TERMINAL

(71) Applicant: Noriyoshi Fukuta, Kanagawa (JP)

(72) Inventor: Noriyoshi Fukuta, Kanagawa (JP)

(73) Assignee: KYOCERA CORPORATION, Kyoto (JP)

(21) Appl. No.: 13/388,637

(22) PCT Filed: Aug. 11, 2011
(86) PCT No.: PCT/JP2011/068390

§ 371 Date: Feb. 2, 2012

(30) Foreign Application Priority Data
Aug. 12, 2010 (JP) 2010-181163

(51) Int. Cl. H04W 24/10

(52) U.S. Cl. CPC H04W 24/10
USPC 455/67.11

(57) ABSTRACT

A radio terminal UE performs a process of storing a measurement log including a measurement result of a radio environment in an idle state and within a measurement duration set by a network, and can discard the measurement log after the lapse of 48 hours since the expiration of the measurement duration. The radio terminal UE transmits, to the network, log storing information indicating that the measurement log is stored, when the radio terminal transits from the idle state to a connected state. The radio terminal UE transmits, to the network, a message notifying that the measurement log is not stored, after the lapse of the 48 hours.

### TECHNICAL FIELD

The present invention relates to a radio measurement collection method and a radio terminal for performing measurement and collection in a radio environment.

### BACKGROUND ART

In a mobile communication system, if a building is built in the vicinity of a radio base station, or if an installation status of a base station in the vicinity of the radio base station changes, the radio environment of the radio base station changes. Therefore, in the past, operators used to make use of a measurement vehicle in which measurement equipment was loaded, and used to perform a drive test for measuring and collecting a radio environment.

Such measurement and collection of the radio environment can contribute to optimization of parameters of the radio base station, for example, but face the problem of too many man-hours and high cost. Thus, according to 3GPP (3rd Generation Partnership Project), which is a project aiming to standardize mobile communication systems, the standards determination of MDT (Minimization of Drive Test), which is a technology for automation of measurement and collection in the radio environment, are being progressed by using a radio terminal belonging to a user (see Non-Patent Documents 1 and 2).

### PRIOR ART DOCUMENT

### Non-Patent Document

[Non-Patent Document 1] 3GPP TR 36.805 V9.0.0 “Study on Minimization of drive-tests in Next Generation Networks”, 2009-12
[Non-Patent Document 2] 3GPP TS 37.320 v0.7.0, “Radio measurement collection for Minimization of Drive Tests (MDT)”, 2010-07

### SUMMARY OF THE INVENTION

According to a Logged MDT, which is a form of MDT, measurement and collection in a radio environment are assumed to be performed based on the below method.

Firstly, a network configured by including a radio base station transmits a measurement configuration message for setting a measurement configuration including a measurement duration to a radio terminal.

Secondly, when the radio terminal is in the idle state (that is in the standby state) and within the measurement duration, the radio terminal performs measurement of the radio environment according to the measurement configuration set by the measurement configuration message, and at the same time, stores a measurement log including the results of the measurement.

Thirdly, when the radio terminal transits from the idle state to the connected state (that is the communicating state), the radio terminal transmits the log storing information indicating that the measurement log is stored to the network.

Fourthly, based on the received log storing information, the network transmits a log report request message requesting the report of the measurement log to the radio terminal.

According to such Logged MDT, the radio terminal must store the measurement log for up to 48 hours (predetermined storing time) after from the time of expiration of the timer of the measurement duration. In other words, the radio terminal need not store the measurement log after 48 hours have elapsed since the expiration of the timer of the measurement duration, and can discard the measurement log.

However, if the radio terminal discards the measurement log after transmitting the log storing information to the network, the network understands that the radio terminal is storing the measurement log, and therefore, an unexpected error might occur in the network.

Therefore, an object of the present invention is to provide a radio measurement collection method and a radio terminal, by which it is possible to prevent the occurrence of an unexpected error in the network.

The present invention has the following features to solve the problems described above.

A feature of a radio measurement collection method according to the present invention is summarized as a radio measurement collection method in which a radio terminal (radio terminal UE) performs a process of storing a measurement log including a measurement result of a radio environment in an idle state and within a measurement duration set by a network (e.g. E-UTRAN and maintenance monitoring device OAM), and can discard the measurement log after the lapse of a predetermined storing time (48 hours) since the expiration of the measurement duration, comprising the steps of: transmitting, from the radio terminal to the network, log storing information indicating that the measurement log is stored, when the radio terminal transits from the idle state to a connected state; and transmitting, from the radio terminal to the network, a message notifying that the measurement log is not stored, after the lapse of the predetermined storing time.

A feature of a radio terminal according to the present invention is summarized as a radio terminal (radio terminal UE) that performs a process of storing a measurement log including a measurement result of a radio environment in an idle state and within a measurement duration set by a network (e.g. E-UTRAN and maintenance monitoring device OAM), and that can discard the measurement log after the lapse of a predetermined storing time (48 hours) since the expiration of the measurement duration, the radio terminal configured to transmit, to the network, log storing information indicating that the measurement log is stored, when the radio terminal transits from the idle state to a connected state, and transmit, to the network, a message notifying that the measurement log is not stored, after the lapse of the predetermined storing time.

### BRIEF DESCRIPTION OF THE DRAWINGS

FIG. 1 is a diagram showing the entire schematic configuration of a mobile communication system.

FIG. 2 is a block diagram showing a configuration of a radio base station.

FIG. 3 is a block diagram showing a configuration of a radio terminal.

FIG. 4 is a sequence diagram showing a radio measurement collection method according to a first embodiment.

FIG. 5 is a sequence diagram showing a radio measurement collection method according to a modification of the first embodiment.

FIG. 6 is a sequence diagram showing a radio measurement collection method according to a second embodiment.

FIG. 7 is a sequence diagram showing a radio measurement collection method according to a third embodiment.

### DESCRIPTION OF THE EMBODIMENTS

A first embodiment through a third embodiment and other embodiments of the present invention are explained below with reference to drawings. In the drawings of each embodiment below, the same or similar symbols have been used in the same or similar sections.

### (1) First Embodiment

In a first embodiment, (1.1) Overview of mobile communication system, (1.2) Configuration of radio base station, (1.3) Configuration of radio terminal, (1.4) Radio measurement collection method, (1.5) Effect of the first embodiment, and (1.6) Modification of the first embodiment are explained.

(1.1) Overview of Mobile Communication System

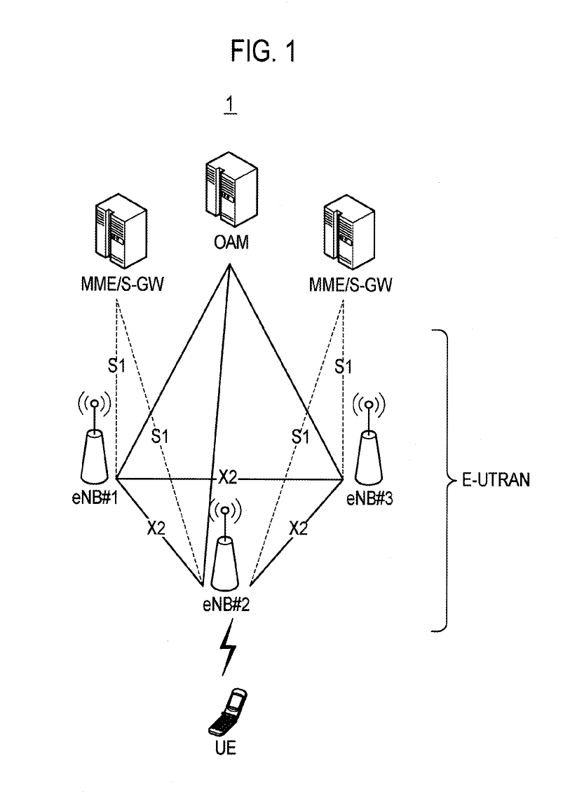

FIG. 1 is a diagram showing the entire schematic configuration of a mobile communication system 1 according to the first embodiment. The mobile communication system 1 is configured based on LTE (Long Term Evolution)-Advanced (also called Rel-10 LTE) whose specifications are stipulated in 3GPP.

As shown in FIG. 1, the mobile communication system 1 includes a radio terminal UE (User Equipment), a plurality of radio base stations eNB (evolved Node-B), a maintenance monitoring device OAM (Operation and Maintenance), and a plurality of mobile management devices MME (Mobility Management Entity)/Gateway devices S-GW (Serving Gateway).

A plurality of radio base stations eNB #1 through eNB #3 configure the radio access network E-UTRAN (Evolved-UMTS Terrestrial Radio Access Network). Each of the plurality of radio base stations eNB forms a cell, which is a communication area that must provide a service to the radio terminal UE. The radio terminal UE is a radio communication device belonging to the user and is also called a user equipment.

Each of the adjacent radio base stations eNB can communicate with each other via an X2 interface, which is a logical communication path that provides communication between base stations. Each of the plurality of radio base stations eNB can communicate with EPC (Evolved Packet Core), specifically, MME (Mobility Management Entity)/S-GW (Serving Gateway) via an S1 interface. Furthermore, each radio base station eNB can communicate with the maintenance monitoring device OAM that is managed by the operator. Note that hereinafter, the radio access network E-UTRAN and the maintenance monitoring device OAM are together appropriately referred to as “network”.

The mobile communication system 1 supports Logged MDT. In the Logged MDT, a radio terminal UE in the idle state performs measurement when the set condition is satisfied, and stores the measurement log that includes the measurement result for reporting it to the network at a later point in time. According to the Logged MDT, measurement collection are performed in the radio environment with the below method.

Firstly, the network transmits an IdleMDTConfiguration message, which is a measurement setting message for setting the measurement configuration, to the radio terminal UE. The measurement configuration includes the measurement targets (measurements to be logged), measurement trigger (triggering of logging event), measurement duration (total duration of logging), time stamp (network absolute time stamp), and measurement area (measurements area). However, the measurement area (measurements area) need not necessarily be included in the measurement configuration. Note that the measurement configuration may be called MDT configuration.

Secondly, the radio terminal UE performs measurement of the radio environment according to the IdleMDTConfiguration message in the idle state and within the measurement duration, and at the same time, stores a measurement log including the results of the measurement. Specifically, the radio terminal UE starts the timer of the measurement duration (duration timer) at the time of setting the measurement configuration based on the IdleMDTConfiguration message, and ends the storing of the measurement log when the timer expires. Note that the radio environment is the reference signal received power (RSRP) and reference signal received quality (RSRQ). Furthermore, in addition to the measurement results of the radio environment, the measurement log may also include the location information and time stamp. The location information is the ECGI information of the serving cell, the GNSS (GPS) information, or the RF fingerprint.

Thirdly, when the radio terminal UE transits from the idle state (RRC Idle state) to the connected state (RRC Connected state), it transmits the log storing information indicating that the measurement log is stored to the network. Specifically, the radio terminal UE includes the log storing information in the RRCConnectionSetupComplete message that indicates the completion of establishment of the connected state, and transmits it to the network.

Fourthly, based on the received log storing information, the network transmits a UEInformationRequest message, which is a log report request message requesting the report of the measurement log, to the radio terminal UE. When the radio terminal UE receives the UEInformationRequest message, it transmits a UEInformationResponse message including the stored measurement log to the network.

According to such Logged MDT, the radio terminal UE must store the measurement log for up to 48 hours (predetermined storing time) after from the time of expiration of the timer of the measurement duration. In other words, the radio terminal UE need not store the measurement log after 48 hours have elapsed since the expiration of the timer of the measurement duration, and can discard the measurement log.

However, if the radio terminal UE discards the measurement log after transmitting the log storing information to the network, the network understands that the radio terminal UE is storing the measurement log, and therefore, regardless of the fact that the radio terminal UE is not storing the measurement log, the UEInformationRequest message is transmitted from the network to the radio terminal UE thereby causing a problem.

Thus, in the first embodiment, by storing the measurement log without erasing it even after the lapse of 48 hours since the expiration of the timer of the measurement duration when the radio terminal UE transmits the log storing information to the network, the above problem is avoided.

(1.2) Configuration of Radio Base Station

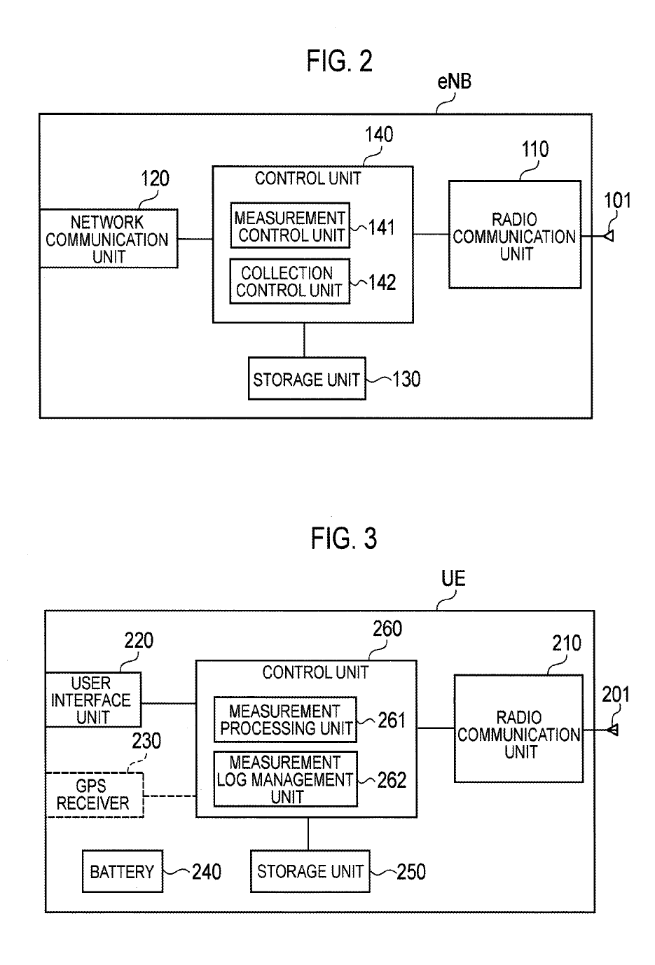

FIG. 2 is a block diagram showing a configuration of the radio base station eNB according to the first embodiment.

As shown in FIG. 2, the radio base station eNB includes an antenna 101, a radio communication unit 110, a network communication unit 120, a storage unit 130, and a control unit 140.

The antenna 101 is used for transmitting and receiving a radio signal. The radio communication unit 110 is configured by using a radio frequency (RF) circuit and a base band (BB) circuit, for example, and transmits and receives a radio signal via the antenna 101. Furthermore, the radio communication unit 110 performs modulation of a transmission signal and demodulation of a reception signal. The network communication unit 120 is configured to perform communication with other network devices (such as the maintenance monitoring device OAM and other radio base stations eNB). The storage unit 130 is configured by using a memory, for example, and stores different types of information used for controlling the radio base station eNB, for example. The control unit 140 is configured by using a CPU, for example, and controls different types of functions of the radio base station eNB.

The control unit 140 has a measurement control unit 141 and a collection control unit 142.

The measurement control unit 141 is configured to generate the IdleMDTConfiguration message for setting the measurement configuration. Also, the measurement control unit 141 controls the radio communication unit 110 so as to transmit the IdleMDTConfiguration message to the radio terminal UE.

The collection control unit 142 is configured to control the collection of the measurement log from the radio terminal UE. The collection control unit 142 generates the UEInformationRequest message. Also, the collection control unit 142 controls the radio communication unit 110 so as to transmit the UEInformationRequest message to the radio terminal UE.

The collection control unit 142 is configured to acquire the measurement log included in the received UEInformationResponse message when the radio communication unit 110 receives the UEInformationResponse message transmitted (reported) from the radio terminal UE in response to the UEInformationRequest message. Also, the collection control unit 142 controls the network communication unit 120 so as to transmit the acquired measurement log to the maintenance monitoring device OAM. Note that the collection control unit 142 is not limited to the case where it transmits the measurement log to the maintenance monitoring device OAM, but can also be used for interpreting the contents of the measurement log and adjusting the parameters of the own radio base station eNB.

(1.3) Configuration of Radio Terminal

FIG. 3 is a block diagram showing a configuration of the radio terminal UE according to the first embodiment.

As shown in FIG. 3, the radio terminal UE includes an antenna 201, a radio communication unit 210, a user interface unit 220, a GPS receiver 230, a battery 240, a storage unit 250, and a control unit 260. However, the radio terminal UE need not necessarily include the GPS receiver 230.

The antenna 201 is used for transmitting and receiving a radio signal. The radio communication unit 210 is configured by using a radio frequency (RF) circuit and a base band (BB) circuit, for example, and transmits and receives a radio signal via the antenna 201. Furthermore, the radio communication unit 210 performs modulation of a transmission signal and demodulation of a reception signal. The user interface unit 220 is a display, button, or the like that functions as an interface with the user. The battery 240 is configured to charge an electric power supplied to each block of the radio terminal UE. The storage unit 250 is configured by using a memory, for example, and stores different types of information used for controlling the radio terminal UE, for example. The control unit 260 is configured by using a CPU, for example, and controls different types of functions of the radio terminal UE.

The control unit 260 has a measurement processing unit 261 and a measurement log management unit 262.

In the connected state, the measurement processing unit 261 is configured to set (that is, to store in the storage unit 250) the measurement configuration designated by the received IdleMDTConfiguration message, when the radio communication unit 210 receives the IdleMDTConfiguration message.

In the idle state, the measurement processing unit 261 is configured to acquire the measurement and location information of the radio environment according to the measurement configuration stored in the storage unit 250, and at the same time, to store (that is, to store in the storage unit 250) the measurement log that includes the measurement result and location information and the like. Specifically, the measurement processing unit 261 performs measurement based on the frequency designated in the measurement targets (measurements to be logged) and the trigger designated in the measurement trigger (triggering of logging event). Furthermore, the measurement processing unit 261 performs measurement only when camping is performed on a cell ID designated in the measurement area (measurements area) or on a tracking area. Note that when the measurement area is not designated, the terminal performs measurement in the cells belonging to all PLMNs to which its location registration is possible.

The measurement processing unit 261 starts the timer of the measurement duration (duration timer) at the time of setting the measurement configuration, ends the storing of the measurement log when the timer expires, and then discards the setting of the measurement configuration.

The measurement log management unit 262 is configured to manage the measurement log stored in the storage unit 250. When the timer of the measurement duration expires, the measurement log management unit 262 starts the 48-hour timer.

When the measurement log is stored in the storage unit 250 and the transition from the idle state to the connected state is complete, the measurement log management unit 262 controls so as to include the log storing information indicating that the measurement log is stored in an RRCConnectionSetupComplete message indicating the completion of transition from the idle state to the connected state, and then transmit it.

In the connected state, the measurement log management unit 262 acquires the measurement log stored in the storage unit 250 when the radio communication unit 210 receives the UEInformationRequest message, and generates a UEInformationResponse message including the acquired measurement log. Also, the measurement log management unit 262 controls the radio communication unit 210 so as to transmit the generated UEInformationResponse message to the network (radio base station eNB). In this way, when the measurement log is reported to the network, the measurement log management unit 262 discards the measurement log stored in the storage unit 250. Furthermore, in the connected state, the measurement log management unit 262 replaces the measurement configuration stored in the storage unit 250 with a new measurement configuration when the radio communication unit 210 receives a new IdleMDTConfiguration message, and at the same time, it can discard the measurement log stored in the storage unit 250.

Additionally, in cases where a report of the measurement log cannot be sent to the network within 48 hours from the expiration of the timer of the measurement duration, the measurement log management unit 262 discards the measurement log. However, in cases where the log storing information is included in the RRCConnectionSetupComplete message and transmitted, the measurement log management unit 262 controls so as to store the measurement logs that have not been transmitted (not reported) to the network even after the lapse of 48 hours since the expiration of the timer of the measurement duration.

(1.4) Radio Measurement Collection Method

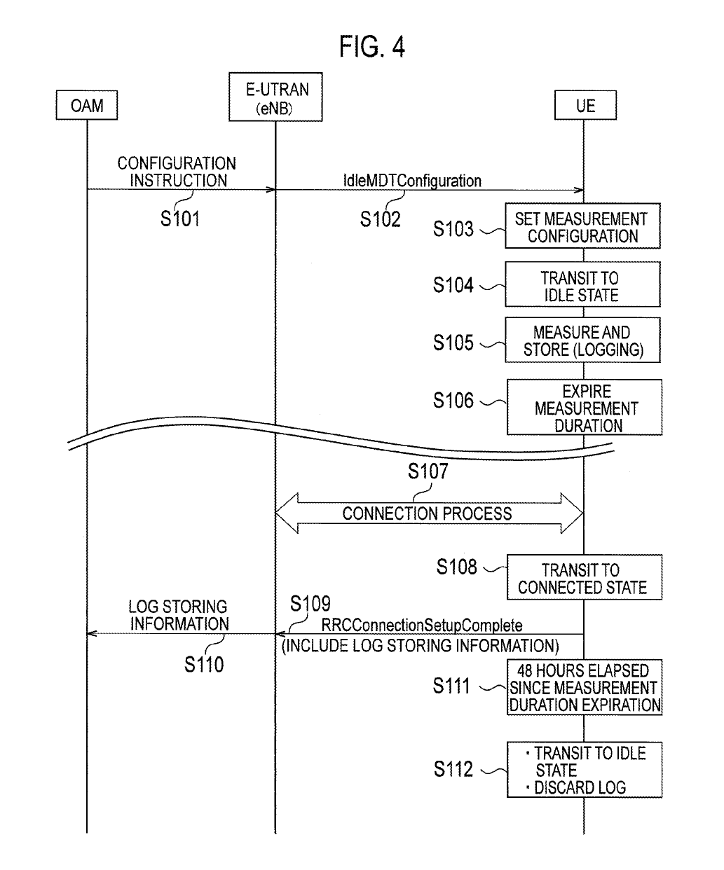

FIG. 4 is a sequence diagram showing a radio measurement collection method according to the first embodiment. In the initial state shown in FIG. 4, the radio terminal UE is in the connected state and performs radio communication with the radio base station eNB.

In step S101, the maintenance monitoring device OAM selects a radio terminal UE to be used in MDT with reference to the information about the mobile management device MME, and decides the measurement configuration to be set in the selected radio terminal UE. Then, the maintenance monitoring device OAM transmits the information about the selected radio terminal UE and the information about the decided measurement configuration to the radio base station eNB.

In step S102, in accordance with the information received from the maintenance monitoring device OAM, the radio base station eNB generates an IdleMDTConfiguration message for setting the measurement configuration, and transmits the generated IdleMDTConfiguration message to the radio terminal UE.

When the radio terminal UE receives the IdleMDTConfiguration message, it sets the measurement configuration included in the received IdleMDTConfiguration message in the own radio terminal UE in step S103. Furthermore, the radio terminal UE starts the timer of the measurement duration (duration timer) at the time of setting the measurement configuration.

In step S104, the radio terminal UE transits from the connected state to the idle state.

In step S105, the radio terminal UE performs the logging process, that is, it performs measurement of the radio environment according to the set measurement configuration, and at the same time, stores the measurement log including the results of the measurement.

When the timer of the measurement duration expires, the radio terminal UE terminates the logging process in step S106. When the timer of the measurement duration expires, the radio terminal UE starts the 48-hour timer.

In step S107, the radio terminal UE performs the process of connecting to the radio base station eNB. Note that there is a high possibility that the radio base station eNB that becomes the connection destination of the radio terminal UE is different from the radio base station eNB to which the IdleMDTConfiguration message is transmitted.

In step S108, the radio terminal UE transits from the idle state to the connected state.

In step S109, the radio terminal UE transmits an RRCConnectionSetupComplete message indicating the completion of the transition from the idle state to the connected state to the radio base station eNB. At that point, the radio terminal UE includes the log storing information indicating that the measurement log is stored as a one-bit indication in the RRCConnectionSetupComplete message, and transmits it.

When the radio base station eNB receives the RRCConnectionSetupComplete message including the log storing information from the radio terminal UE, it transmits information indicating that the radio terminal UE is storing the measurement log to the maintenance monitoring device OAM in step S110. The maintenance monitoring device OAM determines whether or not to collect the measurement log that the radio terminal UE stores.

In step S111, the 48-hour timer expires. When the 48-hour timer expires, the radio terminal UE decides whether or not to discard the measurement log that is stored. Specifically, when the log storing information is included in the RRCConnectionSetupComplete message and transmitted, the radio terminal UE decides that the stored measurement log is not to be discarded. On the other hand, when the log storing information is not transmitted by including it in the RRCConnectionSetupComplete message, the radio terminal UE determines that the stored measurement log can be discarded. In the explanation below, the radio terminal UE decides that the measurement log is not to be discarded.

In step S112, the radio terminal UE transits from the connected state to the idle state. When the radio terminal UE transits from the connected state to the idle state, the radio terminal UE determines that the measurement logs that have not been transmitted (not reported) to the network can be discarded.

Note that from the time the radio terminal UE transmits the RRCConnectionSetupComplete message including the log storing information (step S109) up to the time the radio terminal UE transits to the idle state (step S112), it may be requested by the network to send the report of the measurement log. In such cases, the radio base station eNB receives information indicating an instruction to collect the measurement log that the radio terminal UE stores from the maintenance monitoring device OAM, generates a UEInformationRequest message, and transmits the generated UEInformationRequest message to the radio terminal UE. When the radio terminal UE receives the UEInformationRequest message from the radio base station eNB, the radio terminal UE generates a UEInformationResponse message including the stored measurement log, and transmits the generated UEInformationResponse message to the radio base station eNB. When the measurement log is thus reported to the network, the radio terminal UE discards the stored measurement log. When the radio base station eNB receives the UEInformationResponse message from the radio terminal UE, the radio base station eNB acquires the measurement log included in the received UEInformationResponse message, and transmits the acquired measurement log to the maintenance monitoring device OAM.

(1.5) Effect of the First Embodiment

As described above, according to the first embodiment, when the radio terminal UE transmits the log storing information to the network, the radio terminal UE does not discard the measurement log but stores it up to the time the radio terminal UE transits from the connected state to the idle state even after the lapse of 48 hours since the expiration of the timer of the measurement duration. Thus, regardless of the fact that the radio terminal UE does not store the measurement log, the problem of transmission of the UEInformationRequest message from the network to the radio terminal UE can be avoided.

Furthermore, in the first embodiment, when the radio terminal UE receives the UEInformationRequest message after the lapse of 48 hours since the expiration of the timer of the measurement duration, the radio terminal UE can transmit a UEInformationResponse message including the measurement log to the network, and therefore, the loss of the measurement log can be inhibited.

(1.6) Modification of the First Embodiment

In the first embodiment, when the radio terminal UE transmits the log storing information to the network, the radio terminal UE does not discard the measurement log but stores it up to the time the radio terminal UE transits from the connected state to the idle state even after the lapse of 48 hours since the expiration of the timer of the measurement duration.

In the present modification, when the radio terminal UE transmits the log storing information to the network, the radio terminal UE does not discard the measurement log but stores it for up to after the lapse of a time period (N hours) beyond the 48 hours, even after the lapse of 48 hours since the expiration of the timer of the measurement duration. Any value larger than 0 can be set as the value of N, for example, a value between 5 and 10 can be set.

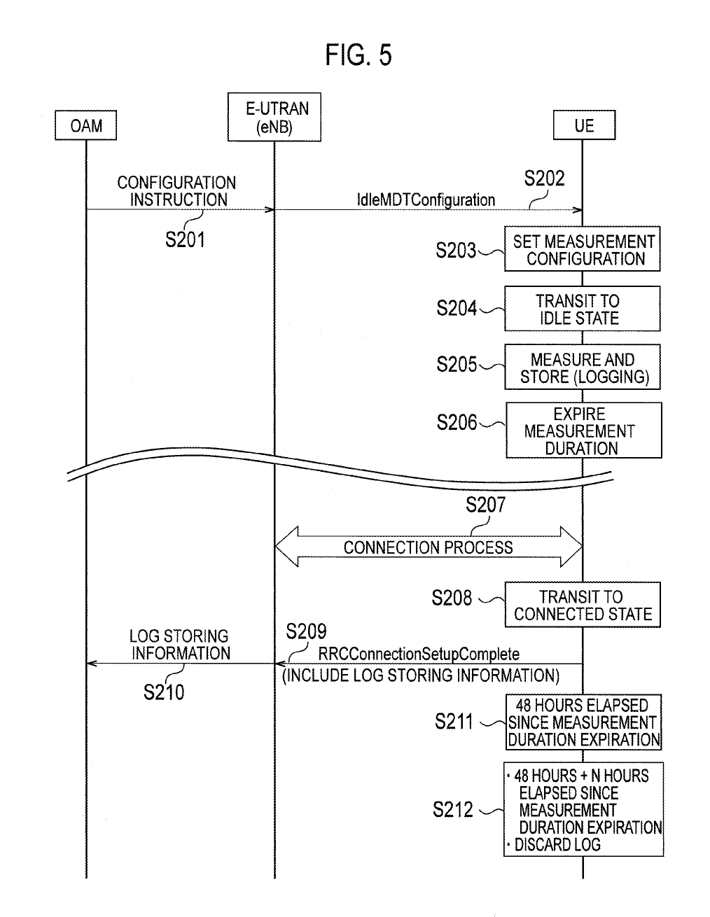

FIG. 5 is a sequence diagram showing a radio measurement collection method according to a modification of the first embodiment. Hereinafter, mainly the differences from the radio measurement collection method according to the first embodiment are explained.

The processes of step S201 through step S210 are the same as those in the first embodiment.

In step S211, the 48-hour timer expires. When the 48-hour timer expires, the radio terminal UE decides whether or not to discard the measurement log that is stored. Specifically, when the log storing information is included in the RRCConnectionSetupComplete message and transmitted, the radio terminal UE decides that the stored measurement log is not to be discarded, and starts the N-hour timer. On the other hand, when the log storing information is not transmitted by including it in the RRCConnectionSetupComplete message, the radio terminal UE determines that the stored measurement log can be discarded. In the explanation below, the radio terminal UE decides that the measurement log is not to be discarded.

In step S212, the N-hour timer expires. When the N-hour timer expires, the radio terminal UE determines that the measurement logs that have not been transmitted (not reported) to the network can be discarded.

Thus, according to the modification of the first embodiment, when the radio terminal UE transmits the log storing information to the network, the radio terminal UE does not discard the measurement log but stores it for up to after the lapse of 48 hours+N hours from the time of expiration of the timer of the measurement duration. Thus, regardless of the fact that the radio terminal UE does not store the measurement log, the problem of transmission of the UEInformationRequest message from the network to the radio terminal UE can be avoided.

Furthermore, in the modification of the first embodiment, when the radio terminal UE receives the UEInformationRequest message after the lapse of 48 hours since the expiration of the timer of the measurement duration, the radio terminal UE can transmit a UEInformationResponse message including the measurement log to the network, and therefore, the loss of the measurement log can be inhibited.

### (2) Second Embodiment

In the second embodiment, when the radio terminal UE discards the measurement log after transmitting the log storing information to the network, the radio terminal UE transmits a predetermined message for regulating the transmission of the UEInformationRequest message to the network. The predetermined message is an erasure notification message that notifies that the measurement log has been discarded, a log non-retention notification message that notifies that the measurement log is not stored, or a regulation request message that requests the transmission regulation of the log report request message.

Hereinafter, the second embodiment is explained in the order of (2.1) Configuration of radio terminal, (2.2) Radio measurement collection method, and (2.3) Effect of the second embodiment.

(2.1) Configuration of Radio Terminal

Again, by using FIG. 3, the differences in the configuration of the radio terminal UE according to the second embodiment with respect to the first embodiment are explained. In the radio terminal UE according to the second embodiment, when a report of the measurement log cannot be sent to the network within 48 hours since the expiration of the timer of the measurement duration, the measurement log management unit 262 discards the measurement log. Furthermore, when the measurement log management unit 262 discards the measurement log due to a lapse of 48 hours after the transmission of the log storing information to the network, the measurement log management unit 262 generates a predetermined message for regulating the transmission of the UEInformationRequest message. Also, the measurement log management unit 262 controls the radio communication unit 210 so as to transmit the generated predetermined message to the network.

(2.2) Radio Measurement Collection Method

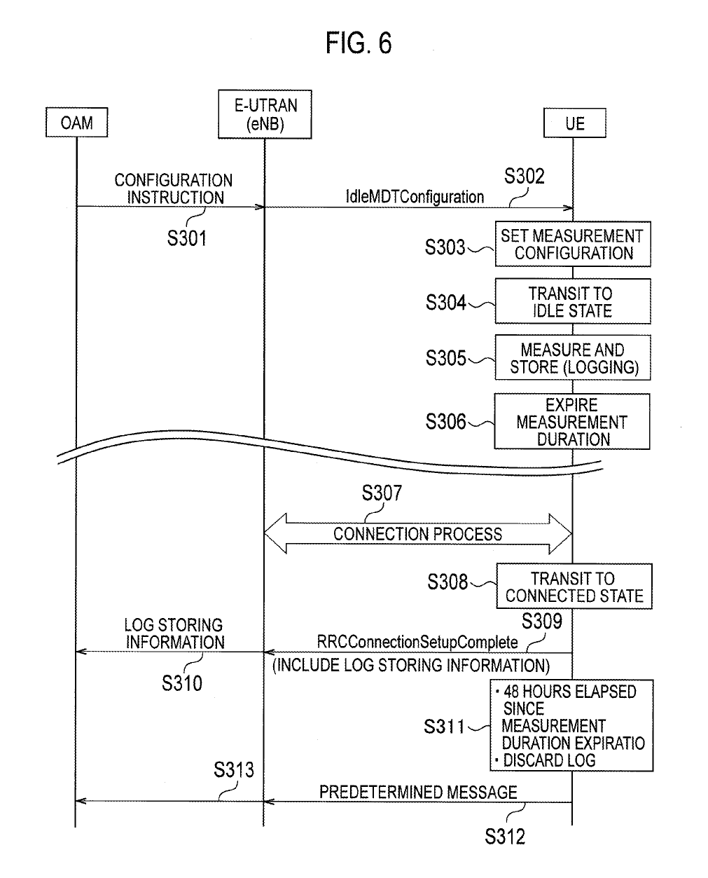

FIG. 6 is a sequence diagram showing a radio measurement collection method according to the second embodiment. Hereinafter, mainly the differences from the radio measurement collection method according to the first embodiment are explained.

The processes of step S301 through step S310 are the same as those in the first embodiment.

In step S311, the 48-hour timer expires. When the 48-hour timer expires, the radio terminal UE can discard the stored measurement log.

When the log storing information is included in the RRCConnectionSetupComplete message and transmitted, the radio terminal UE transmits a predetermined message to the radio base station eNB in step S312. The predetermined message is an erasure notification message that notifies that the measurement log has been discarded, a log non-retention notification message that notifies that the measurement log is not stored, or a regulation request message that requests the transmission regulation of the log report request message.

When the radio base station eNB receives a predetermined message from the radio terminal UE, the radio base station eNB transmits a message corresponding to the predetermined message to the maintenance monitoring device OAM in step S313.

(2.3) Effect of the Second Embodiment

As described above, according to the second embodiment, when the radio terminal UE transmits the log storing information to the network, the radio terminal UE discards the measurement log after the lapse of 48 hours since the expiration of the timer of the measurement duration, and at the same time, transmits a predetermined message to the network. Thus, regardless of the fact that the radio terminal UE does not store the measurement log, the problem of transmission of the UEInformationRequest message from the network to the radio terminal UE can be avoided.

### (3) Third Embodiment

In the third embodiment, when 48 hours have elapsed after the transmission of the log storing information to the network, the radio terminal UE transmits a query message inquiring about whether or not the measurement log can be discarded to the network.

Hereinafter, the third embodiment is explained in the order of (3.1) Configuration of radio terminal, (3.2) Radio measurement collection method, and (3.3) Effect of the third embodiment.

(3.1) Configuration of Radio Terminal

Again, by using FIG. 3, the differences in the configuration of the radio terminal UE according to the third embodiment with respect to the first embodiment are explained. In the radio terminal UE according to the third embodiment, when 48 hours have elapsed after the transmission of the log storing information to the network, the measurement log management unit 262 generates a query message inquiring about whether or not the measurement log can be discarded. The measurement log management unit 262 controls the radio communication unit 210 so as to transmit the generated query message to the network. Also, when a message notifying that the measurement log can be discarded is received from the network, the measurement log management unit 262 controls so as to discard the measurement log.

(3.2) Radio Measurement Collection Method

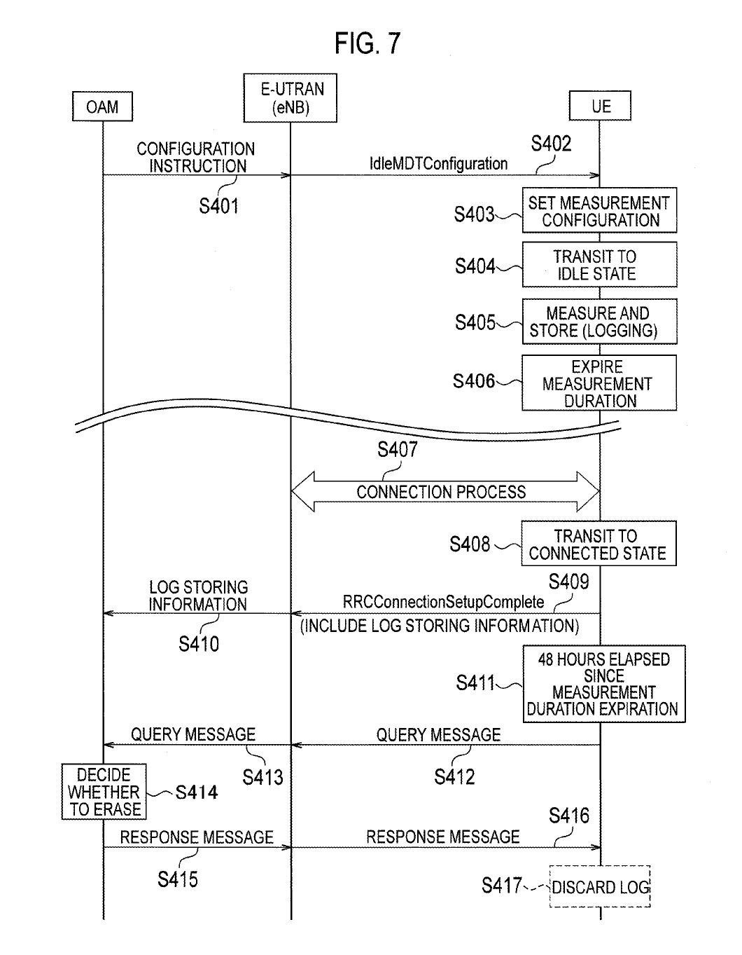

FIG. 7 is a sequence diagram showing a radio measurement collection method according to the third embodiment. Hereinafter, mainly the differences from the radio measurement collection method according to the first embodiment are explained.

The processes of step S401 through step S410 are the same as those in the first embodiment.

In step S411, the 48-hour timer expires.

When the 48-hour timer expires, the radio terminal UE transmits a query message inquiring about whether or not the measurement log can be discarded to the radio base station eNB, in step S412.

When the radio base station eNB receives a query message from the radio terminal UE, the radio base station eNB transmits a message corresponding to the query message to the maintenance monitoring device OAM in step S413.

When the maintenance monitoring device OAM receives the message corresponding to the query message from the radio base station eNB, the maintenance monitoring device OAM decides whether or not to allow the erasure of the measurement log in step S414. For example, the maintenance monitoring device OAM decides whether or not to allow the erasure of the measurement log based on the importance of the measurement log specified in accordance with the measurement configuration decided in step S401. The maintenance monitoring device OAM assumes high importance for the measurement configuration configured to perform measurement in a specific area and/or time, and decides that the erasure of the measurement log is not allowed. On the other hand, the maintenance monitoring device OAM assumes low importance for the measurement configuration configured to perform measurement in other than a specific area and/or time, and decides that the erasure of the measurement log is allowed.

In step S415, the maintenance monitoring device OAM transmits a response message in accordance with the decision result of step S414 to the radio base station eNB.

When the radio base station eNB receives a response message in accordance with the decision result from the maintenance monitoring device OAM, the radio base station eNB transmits a message corresponding to the received response message to the radio terminal UE in step S416.

When the message received from the radio base station eNB allows the erasure of the measurement log, the radio terminal UE discards the measurement login step S417. On the other hand, when the message received from the radio base station eNB does not allow the erasure of the measurement log, the radio terminal UE stores the measurement log without erasing it.

Note that in place of the above response message, a UEInformationRequest message can also be sent.

Furthermore, in the present sequence, the maintenance monitoring device OAM decides whether or not to allow the erasure of the measurement log, however, the radio base station eNB can also decide the same. In such a case, whether or not to allow the erasure of the measurement log can be decided based on the load status of the radio base station eNB, for example.

(3.3) Effect of the Third Embodiment

As described above, according to the third embodiment, after the lapse of 48 hours since the expiration of the timer of the measurement duration when the log storing information is transmitted to the network, the radio terminal UE transmits a query message inquiring about whether or not the measurement log can be discarded to the network. Thus, regardless of the fact that the radio terminal UE does not store the measurement log, the problem of transmission of the UEInformationRequest message from the network to the radio terminal UE can be avoided.

### (4) Other Embodiments

The present invention is explained through each of the above embodiments, but it must not be understood that this invention is limited by the statements and drawings constituting a part of this disclosure. From this disclosure, a variety of alternate embodiments, examples, and applicable techniques will become apparent to one skilled in the art.

For example, in each embodiment, a mobile communication system 1 configured based on LTE or LTE-Advanced was explained, however, the present invention is not limited to LTE or LTE-Advanced, and can also be applied to mobile communication systems configured based on W-CDMA.

Thus, it must be understood that the present invention includes various embodiments that are not described herein. The entire contents of Japanese Patent Application Laid-open No. 2010-181163 (filed on Aug. 12, 2010) are incorporated in the present specification by reference.

### INDUSTRIAL APPLICABILITY

As described above, because the occurrence of an unexpected error in the network can be prevented based on the radio measurement collection method and radio terminal according to the present invention, the method and the terminal are useful in radio communication such as mobile communication.

1. A radio measurement collection method in which a radio terminal performs a process of storing a measurement log including a measurement result of a radio environment in an idle state and within a measurement duration set by a network, and can discard the measurement log after the lapse of a predetermined storing time since the expiration of the measurement duration, comprising the steps of:
transmitting, from the radio terminal to the network, log storing information indicating that the measurement log is stored, when the radio terminal transits from the idle state to a connected state; and
transmitting, from the radio terminal to the network, a message notifying that the measurement log is not stored, after the lapse of the predetermined storing time.

2. A radio terminal that performs a process of storing a measurement log including a measurement result of a radio environment in an idle state and within a measurement duration set by a network, and that can discard the measurement log after the lapse of a predetermined storing time since the expiration of the measurement duration, the radio terminal configured to
transmit, to the network, log storing information indicating that the measurement log is stored, when the radio terminal transits from the idle state to a connected state, and
transmit, to the network, a message notifying that the measurement log is not stored, after the lapse of the predetermined storing time.
